(19) United States
(12) Patent Application Publication
(10) Pub. No.: US 2026/0351830 A1
(43) Pub. Date: Nov. 5, 2026

(54) STRUCTURE FOR TRANSITIONING A SIGNAL FROM A WAVEGUIDE MEDIUM TO PRINTED CIRCUIT BOARD STRIPLINE MEDIUM

(71) Applicant: Raytheon Company, Arlington, VA (US)

(72) Inventors: Channing P. Favreau, Barre, MA (US); Alexander T. Gilbert, Boston, MA (US); Wei Yu, Natick, MA (US)

(21) Appl. No.: 19/198,744

(22) Filed: May 5, 2025

(51) Int. Cl. H01P 5/08; H01P 3/06

(52) U.S. Cl. CPC H01P 5/085; H01P 3/06

(57) ABSTRACT

Embodiments of an additively manufactured waveguide transmission line coupled to a printed circuit board is configured to transition a signal from a waveguide transmission line medium to printed circuit board stripline medium are described herein. The waveguide transmission line has a center conductive ridge within an interior cavity and extending throughout a length of the waveguide transmission line. The printed circuit board may include a stripline conductor provided between a first ground plane and second ground planes. The stripline includes at least one of an open or short-circuited tuning stub provided at a distance from the center conductive ridge. The waveguide transmission line includes a conductive interface configured to mate with a first metalized region of the printed circuit board that is grounded and electrically coupled to the first ground plane. The waveguide transmission line operates as a coaxial waveguide having a substantially circular cross section and the center conductive ridge operates as a center conductor.

### TECHNICAL FIELD

Some embodiments pertain to signal transmission mediums such as waveguides and stripline mediums.

### BACKGROUND

The development of radio frequency (RF) components using additive manufacturing (AM) has advanced significantly, with examples including waveguides and coaxial lines. However, integrating these components into larger systems, especially with printed circuit boards remains a significant challenge. Specifically, interfacing additively manufactured coaxial lines that uses air as a dielectric present unique difficulties. The lack of robust methods to support the inner conductor and establish reliable connections to printed circuit boards limits their practical implementation and adoption in RF systems.

Some issues with transitioning signals from waveguide medium to a printed circuit board stripline medium include impedance matching since waveguides typically have different characteristic impedances than stripline. Any mismatch causes signal reflections, reducing power transfer and potentially creating standing waves. Another issue with transitioning signals from waveguide medium to a printed circuit board stripline medium is mode conversion since waveguides support transverse electric (TE) and transvers magnetic (TM) modes while stripline use quasi-TEM modes. Another issue with transitioning signals from waveguide medium to a printed circuit board stripline medium is bandwidth limitations since transitions often have narrower bandwidth than either the waveguide or stripline alone.

Thus, there are general needs for structures that transition signals from waveguide medium to a printed circuit board stripline medium.

### BRIEF DESCRIPTION OF THE DRAWINGS

FIG. 1A illustrates a cross section of a structure for transitioning a signal from a waveguide transmission line medium to a stripline medium, in accordance with some embodiments.

FIG. 1B illustrates a perspective view of a cross section of the structure of FIG. 1A, in accordance with some embodiments.

FIG. 2 illustrates various conductive elements of a printed circuit board of the structure of FIG. 1A and FIG. 1B, in accordance with some embodiments.

FIG. 3 illustrates an end of a waveguide transmission line of the structure of FIG. 1A and FIG. 1B, in accordance with some embodiments.

FIG. 4 illustrates conductive elements of a printed circuit board mated with a waveguide transmission line of the structure of FIG. 1A and FIG. 1B, in accordance with some embodiments.

FIG. 5 illustrates propagation of RF signals transitioning from a waveguide transmission line medium to a stripline medium, at substantially ninety-degrees, in accordance with some embodiments.

FIG. 6 illustrates an additively manufactured waveguide transmission line in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some embodiments are directed to an additively manufactured waveguide transmission line coupled to a printed circuit board that is configured to transition a signal from a waveguide transmission line medium to printed circuit board stripline medium. The waveguide transmission line may have a center conductive ridge within an interior cavity and extending throughout a length of the waveguide transmission line. The printed circuit board may have a stripline conductor provided between a first ground plane and a second ground plane and may be electrically connected by a plurality of conductive plated-through-hole (PTH) vias. The stripline includes at least one of an open or short-circuited tuning stub provided at a distance from the center conductive ridge. The waveguide transmission line includes a conductive interface configured to mate with a first metalized region of the printed circuit board that is grounded and electrically coupled to the first ground plane. The waveguide transmission line operates as a coaxial waveguide having a substantially circular cross section and wherein the center conductive ridge operates as a center conductor. These embodiments, as well as others, are described in more detail herein.

Some embodiments are directed to a structure to transition a signal from a waveguide transmission line medium to printed circuit board stripline medium. These embodiments, as well as others, are described in more detail herein.

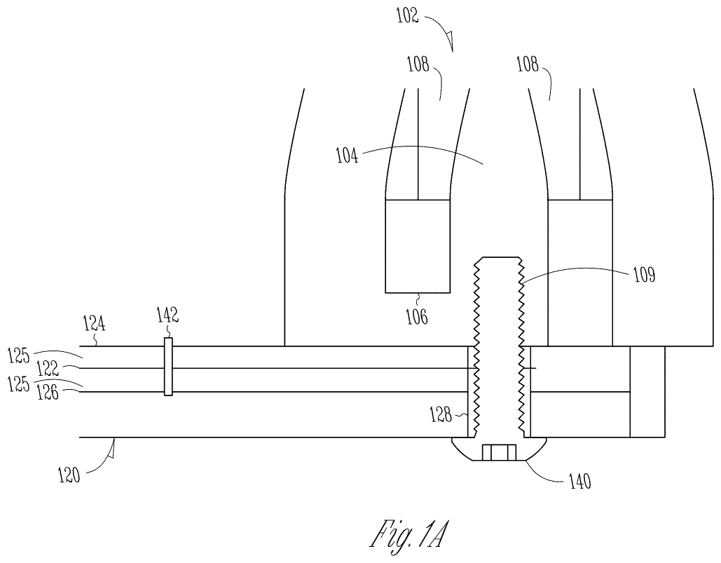

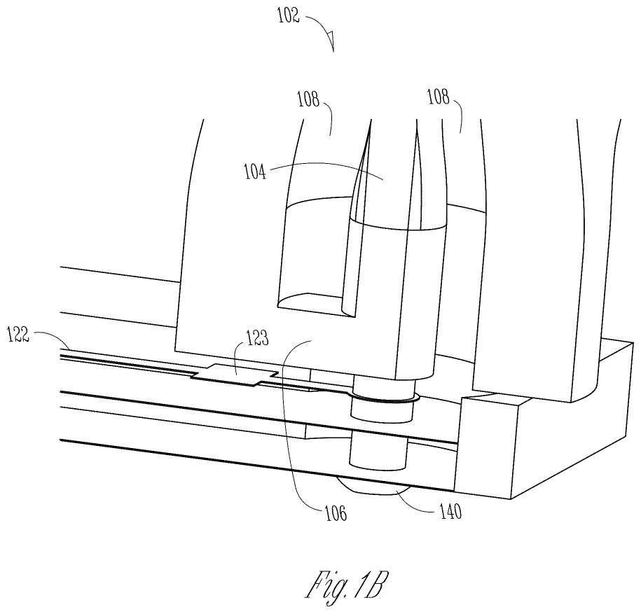

FIG. 1A illustrates a cross section of a structure for transitioning a signal from a waveguide transmission line medium to a stripline medium, in accordance with some embodiments. FIG. 1B illustrates a perspective view of a cross section of the structure of FIG. 1A, in accordance with some embodiments. The structure may comprise a waveguide transmission line 102 having a center conductive ridge 104 within an interior cavity 108 and extending throughout a length of the waveguide transmission line 102, and a printed circuit board 120 comprising a stripline conductor 122 provided between a first ground plane 124 and second ground planes 126, the first and second ground planes being electrically connected by a plurality of conductive plated-through-hole (PTH) vias 142. In these embodiments, the stripline conductor 122 includes at least one of an open or short-circuited tuning stub 123 provided at a distance from the center conductive ridge 104 to impedance match the waveguide transmission line medium to the printed circuit board stripline medium.

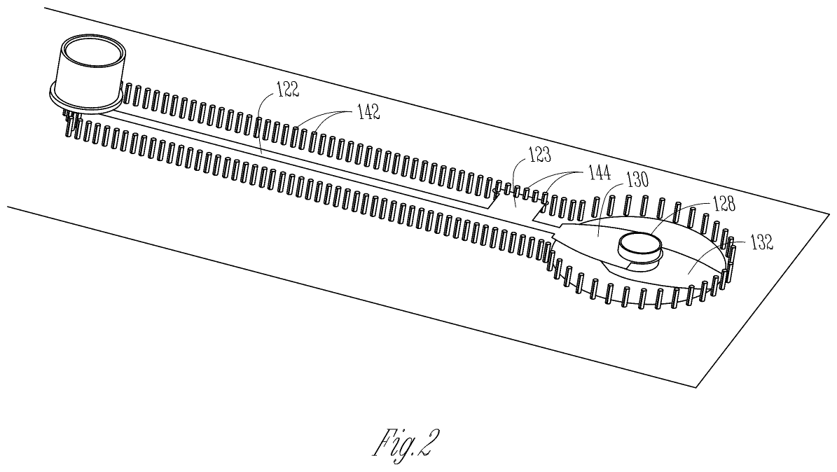

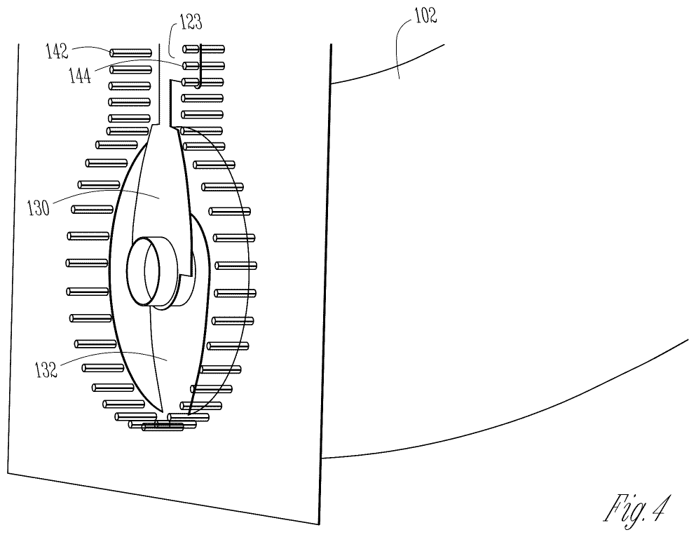

In these embodiments, the waveguide transmission line 102 includes a conductive interface 106 configured to mate with a first metalized region 132 (see FIG. 2 and FIG. 4) of the printed circuit board 120 that is grounded and electrically coupled to the first ground plane 124.

FIG. 2 illustrates various conductive elements of a printed circuit board of the structure of FIG. 1A and FIG. 1B, in accordance with some embodiments. In some embodiments, the first metalized region 132 of the printed circuit board 120 that is coupled to the first ground plane 124 and a second metalized region 130 (see FIG. 2 and FIG. 4) of the printed circuit board 120 that is electrically coupled to the stripline conductor 122 have a shape corresponding to a shape of the conductive interface 106 configured to guide the signal from the waveguide transmission line medium to the printed circuit board stripline medium.

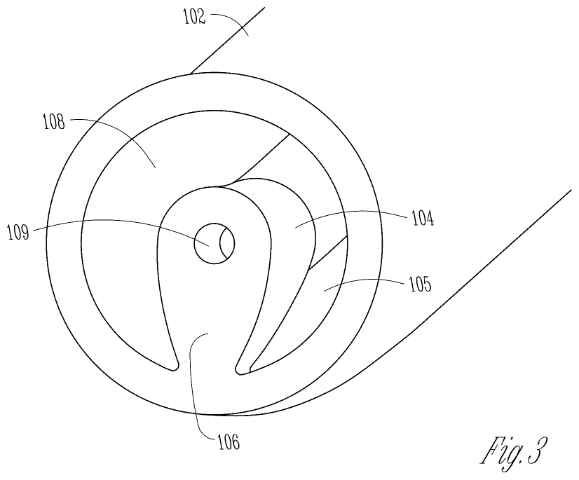

In these embodiments, the conductive interface 106 is at the end of the center conductive ridge 104 and is grounded to interior walls of the waveguide transmission line 102 via the conductive interface (see FIG. 3). In these embodiments, conductive interface 106 may be the mating surface that mates with the first metalized region 132 (see FIG. 2 and FIG. 4) to guide the E field from the waveguide medium to the stripline medium.

FIG. 3 illustrates an end of a waveguide transmission line of the structure of FIG. 1A and FIG. 1B, in accordance with some embodiments. In some embodiments, the tuning stub 123 may be an open or short-circuited tuning stub. In these embodiments, when the tuning stub 123 is a short-circuited tuning stub 123, an end of the stub 123 is electrically coupled to both the first ground plane 124 and the second ground plane 126 by some of the conductive PTH vias 144 (see FIG. 2).

Some embodiments may comprise a fastener 140 coupling the printed circuit board 120 to the waveguide transmission line 102. The fastener may be provided through the printed circuit board and into a threaded interface 109 (e.g., a threaded hole) of the center conductive ridge 104. In these embodiments, the fastener, when tightened, may be configured to cause the conductive interface 106 to mate with the metalized region 132 of the printed circuit board 120.

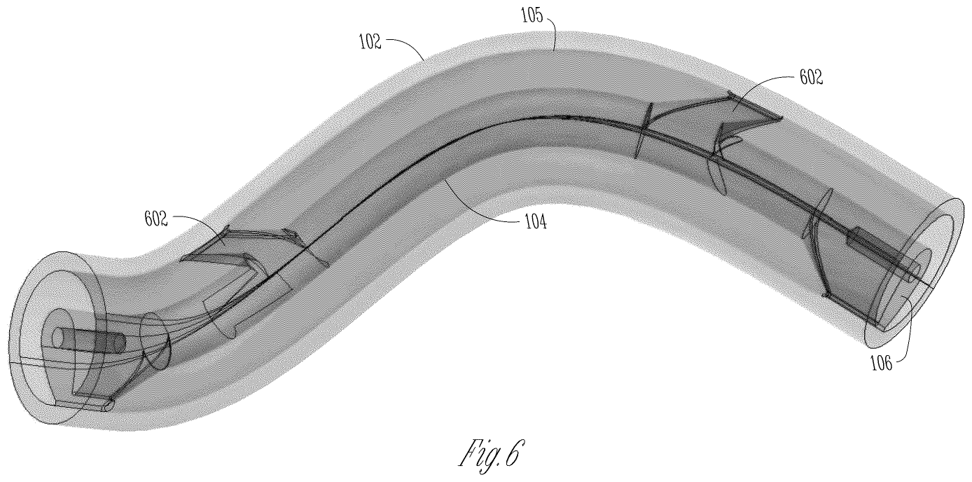

In some embodiments, the waveguide transmission line 102 operates as a coaxial waveguide having a substantially circular cross section. In these embodiments, the center conductive ridge 104 may operate as a center conductor (see FIG. 3). In these embodiments, the waveguide transmission line 102 may further include short-circuit stubs 602 (FIG. 6) strategically placed along the center conductive ridge 104 within the waveguide transmission line 102. The short-circuit stubs 602 may be coupled to inner walls of the waveguide transmission line 102. In these embodiments, stub locations may be optimized for the frequency of operation. The short-circuit stubs are mechanically connected the inner conductor of the waveguide transmission line 102 to provide mechanical support to the center conductive ridge 104.

In some embodiments, the waveguide transmission line 102 may support transverse electric (TE) and transverse magnetic (TM) modes, although the scope of the embodiments is not limited in this respect. In some embodiments, the center conductive ridge 104 may be connected at various locations to inner walls of the waveguide transmission line 102 to provide the short-circuit stubs 602 (FIG. 6) and to support the center conductive ridge 104. In these embodiments, gaps 105 are provided in between the various locations. In some embodiments, the waveguide transmission line 102 may be a three-dimensional (3D) printed waveguide transmission line formed by additive manufacturing (AM) process.

As shown in FIG. 3, one of several gaps 105 is provided between the center conductive ridge 104 and the interior walls of the waveguide transmission line 102. In these embodiments, the center conductive ridge 104 may be described as a ridge-bridge-ridge-bridge configuration throughout the waveguide transmission line 102 (i.e., the center conductor is connected to ground every certain distance with gaps 105 in between). In these embodiments, the center conductive ridge 104 may extend throughout the waveguide but with some gaps 105 between the ridge and the inner walls. In these embodiments, because the waveguide transmission line 102 is 3D printed, the center conductor may be formed like a ridge at some points to retain it.

In some embodiments, stripline conductor 122 and the first ground plane 124 and the second ground plane 126 of the printed circuit board 120 may be configured to operate as a stripline transmission line. In these embodiments, the stripline conductor 122 may be separated from the first and second ground planes 124 and 126 by insulating layers 125 (See FIG. 1A).

In some embodiments, the cavity 108 (see FIG. 1A and FIG. 1B) includes a dielectric. In these embodiments, the dielectric may be air, although the scope of the embodiments is not limited in this respect. In some embodiments, the signal to be transitioned from a waveguide transmission line medium to printed circuit board stripline medium may be a radio frequency (RF) signal, a microwave signal or a millimeter wave signal. In some embodiments, the structure may be tuned from microwave signals ranging between 5 and 10 GHz with up to a 2 GHz bandwidth or greater, although the scope of the embodiments is not limited in this respect.

Some embodiments are directed to a structure for transitioning a signal between a waveguide transmission line medium and printed circuit board stripline medium. In these embodiments, the structure may comprise a waveguide transmission line 102 and a printed circuit board 120. In these embodiments, the structure may be configured to receive a transverse electric (TE) mode signal 502 propagating in the waveguide transmission line 102 and transition the signal to primarily a transverse electromagnetic (TEM) mode signal 504 to propagate in the printed circuit board 120. In these embodiments, the waveguide transmission line 102 may have a center conductive ridge 104 within an interior cavity 108 and extending throughout a length of the waveguide transmission line 102. The printed circuit board 120 may have a stripline conductor 122 provided between a first ground plane 124 and second ground planes 126, and the stripline conductor 122 may include an open or short-circuited tuning stub 123 provided at a distance from the center conductive ridge 104 to impedance match the waveguide transmission line medium to the printed circuit board stripline medium. In these embodiments, the waveguide transmission line 102 may include a conductive interface 106 configured to mate with a first metalized region 132 of the printed circuit board 120 that is grounded and electrically coupled to the first ground plane 124.

Some embodiments are directed to an additively manufactured waveguide transmission line 102 coupled to a printed circuit board 120 is configured to transition a signal from a waveguide transmission line medium to printed circuit board stripline medium. The waveguide transmission line 102 has a center conductive ridge 104 within an interior cavity 108 and extending throughout a length of the waveguide transmission line 102. The printed circuit board 120 may comprise a stripline conductor 122 provided between a first ground plane 124 and second ground planes 126. The first and second ground planes may be electrically connected by a plurality of conductive plated-through-hole (PTH) vias 142. The stripline conductor 122 includes at least one of an open or short-circuited tuning stub 123 provided at a distance from the center conductive ridge 104. The waveguide transmission line 102 includes a conductive interface 106 configured to mate with a first metalized region 132 of the printed circuit board 120 that is grounded and electrically coupled to the first ground plane 124. The waveguide transmission line 102 operates as a coaxial waveguide having a substantially circular cross section. In these embodiments, the center conductive ridge 104 operates as a center conductor.

FIG. 4 illustrates conductive elements of a printed circuit board mated with a waveguide transmission line of the structure of FIG. 1A and FIG. 1B, in accordance with some embodiments. The interface between a waveguide transmission line 102 and a printed circuit board 120 illustrated in FIG. 4 may be configured for transitioning a signal from a waveguide transmission line medium to printed circuit board stripline medium.

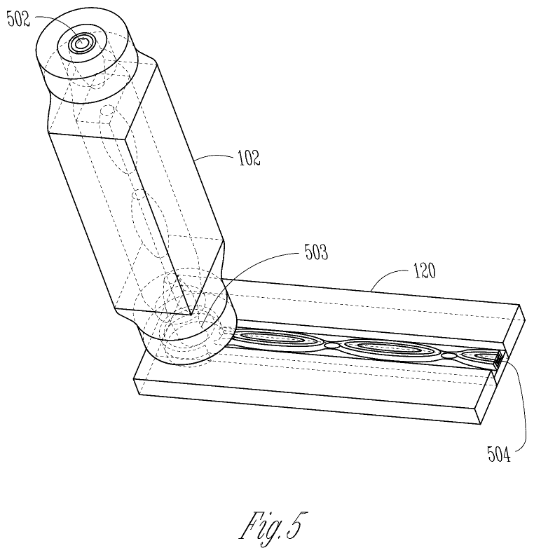

FIG. 5 illustrates propagation of RF signals transitioning from a waveguide transmission line medium to a stripline medium, at substantially ninety-degrees, in accordance with some embodiments. In these embodiments, the printed circuit board 120 may be coupled to the waveguide transmission line 102 at substantially a ninety-degree angle 503 transitioning the signal from primarily a transverse electric (TE) mode signal 502 propagating in the waveguide transmission line 102 to primarily a transverse electromagnetic (TEM) mode signal 504 propagating in the printed circuit board 120. An example of this is illustrated in FIG. 5. In these embodiments, the signal propagates through the waveguide transmission line 102 mainly in TE mode and the signal prorogates through the stripline configuration of the printed circuit board 120 in TEM mode.

FIG. 6 illustrates an additively manufactured waveguide transmission line in accordance with some embodiments. As illustrated in FIG. 6, the waveguide transmission line 102 has a substantially circular cross section and the center conductive ridge 104 may operate as a center conductor. In these embodiments, the waveguide transmission line 102 may further include short-circuit stubs 602 placed along the center conductive ridge 104 within the waveguide transmission line 102. The short-circuit stubs 602 may be coupled to inner walls of the waveguide transmission line 102. In these embodiments, stub locations may be optimized for the frequency of operation and for impedance matching. The short-circuit stubs 602 are mechanically connected the inner conductor of the waveguide transmission line 102 to provide mechanical support to the center conductive ridge 104. In these embodiments, gaps 105 are provided in between the short-circuit stubs 602. In these embodiments, the waveguide transmission line 102 may be a three-dimensional (3D) printed waveguide transmission line formed by additive manufacturing (AM) process.

Embodiments disclosed herein introduce short-circuit stubs to the additively manufactured coaxial transmission line, enhancing both its mechanical and electrical integration. In some embodiments, a short circuit stub is incorporated at the interface with the printed circuit board. In some embodiments, the stub may enable a simplified connection by allowing a single ground connection to serve as the sole interface with the printed circuit board helping to eliminate a need for separate signal and ground connections. These embodiments may significantly reduce complexity and enhances the reliability of the interface.

To further support the inner conductor and ensure proper impedance matching, in some embodiments, additional short-circuit stubs 602 (FIG. 6) are strategically included along the coaxial waveguide transmission line. The stub locations may be optimized for the frequency of operation. The stubs may also mechanically and electrically connect the inner conductor to the outer conductor, stabilizing the structure and improving the RF performance by minimizing the impedance mismatches.

In some embodiments, the interface between the waveguide transmission line and the printed circuit board may be established through assembly contact, using a screw (either conductive or non-conductive). This approach eliminates the need for traditional connectors, which can be bulky, costly and prone to additional signal losses.

In some embodiments, a vertical coaxial connection within the printed circuit board is provided which may be supplemented with tuning features to optimize performance. This design allows the use of conductive or non-conductive screws to securely bolt the center conductor to the printed circuit board, further streamlining assembly and reducing the reliance on bulky, expensive connectors. In some embodiments, to achieve impedance matching and structural stability, additional short-circuit or open-circuit stubs, as well as tapers, may be synthesized or realized using optimization techniques or artificial intelligence. These features may be tailored to the desired frequency range, ensuring robust RF performance and minimal impedance mismatches.

Embodiments disclosed herein may be adaptable and support various planar transmission line configurations such as stripline, microstrip, coplanar waveguide (CPW) on or within printed circuit boards. Furthermore, some embodiments may incorporate either short-circuit or open-circuit stub tuning networks, providing flexibility for a wide range of RF applications.

Embodiments disclosed herein may depart from the traditional reliance on discrete connectors by leveraging additive manufacturing capabilities to embed tuning and support features directly into the transmission line.

Some embodiments may additively incorporate a short circuit stub to the waveguide transmission line where it interfaces with a printed circuit board.

In some embodiments, a short circuit stub at the interface allows a single ground connection to be the only connection to a printed circuit board, rather than separate signal and ground connections.

In some embodiments, a connection between the waveguide transmission line and a printed circuit board can then be made by assembly contact with the use of screws (conductive or non-conductive).

Some embodiments provide a low cost/low loss way of interfacing with 3D printed transmission lines because no additional connectors are needed.

In some embodiments, a short circuit stub at the interface allows a single ground connection to make the connection rather than separate signal and ground connection.

In some embodiments, a simple vertical coaxial connection within a printed circuit board may be used with the addition of tuning features.

In some embodiments, either non-conductive or conductive screw(s) may be used to bolt the center conductor to a printed circuit board.

Some embodiments may use either short circuit or open circuit stub tuning networks on the printed circuit board.

Additional short circuit/open circuit stubs and tapers may be synthesized or realized within the waveguide transmission line using optimization or AI to tune to the desired frequency range.

Some embodiments may be configured to launch signals into strip line, microstrip, CPW and other transmission lines within/on a printed circuit board.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A structure to transition a signal from a waveguide transmission line medium to printed circuit board stripline medium, the structure comprising:
a waveguide transmission line having a center conductive ridge within an interior cavity and extending throughout a length of the waveguide transmission line; and
a printed circuit board comprising a stripline conductor provided between a first ground plane and a second ground plane, the first and second ground planes being electrically connected by a plurality of conductive plated-through-hole (PTH) vias; and
wherein the stripline includes at least one of an open or short-circuited tuning stub provided at a distance from the center conductive ridge to impedance match the waveguide transmission line medium to the printed circuit board stripline medium, and
wherein the waveguide transmission line includes a conductive interface configured to mate with a first metalized region of the printed circuit board that is electrically coupled to the first ground plane.

2. The structure of claim 1, wherein the first metalized region of the printed circuit board that is coupled to the first ground plane and a second metalized region of the printed circuit board that is electrically coupled to the stripline have a shape corresponding to a shape of the conductive interface configured to guide the signal from the waveguide transmission line medium to the printed circuit board stripline medium.

3. The structure of claim 2, wherein the printed circuit board is coupled to the waveguide transmission line at substantially a ninety-degree angle transitioning the signal from primarily a transverse electric (TE) mode signal propagating in the waveguide transmission line to primarily a transverse electromagnetic (TEM) mode signal propagating in the printed circuit board.

4. The structure of claim 3, wherein the at least one tuning stub is one of an open or short-circuited tuning stub, and
wherein when the tuning stub is a short-circuited tuning stub, an end of the stub is electrically coupled to both of the first ground plane and the second ground plane by some of the conductive PTH vias.

5. The structure of claim 4, further comprising a fastener coupling the printed circuit board to the waveguide transmission line, the fastener provided through the printed circuit board and into a threaded interface of the center conductive ridge,
wherein the fastener, when tightened, is configured to cause the conductive interface to mate with the metalized region of the printed circuit board.

6. The structure of claim 5, wherein the waveguide transmission line operates as a coaxial waveguide having a substantially circular cross section and wherein the center conductive ridge operates as a center conductor,
wherein the waveguide transmission line further includes short-circuit stubs along the center conductive ridge within the waveguide transmission line, the short-circuit stubs coupled to inner walls of the waveguide transmission line.

7. The structure of claim 6, wherein the waveguide transmission line is a three-dimensional (3D) printed waveguide transmission line formed by additive manufacturing (AM) process.

8. The structure of claim 7, wherein the center conductive ridge is connected at various locations to inner walls of the waveguide transmission line to provide the short-circuit stubs and to support the center conductive ridge, wherein gaps are provided in between the various locations.

9. The structure of claim 2, wherein stripline conductor and the first ground plane and the second ground plane of the printed circuit board are configured to operate as a stripline transmission line, and
wherein the stripline conductor is separated from the first and second ground planes and by insulating layers.

10. The structure of claim 9, wherein the cavity includes a dielectric, wherein the dielectric is air, and wherein the signal is one of a radio frequency (RF) signal, a microwave signal and a millimeter wave signal.

11. A structure for transitioning a signal between a waveguide transmission line medium and printed circuit board stripline medium, the structure comprising a waveguide transmission line and a printed circuit board, the structure configured to:
receive a transverse electric (TE) mode signal propagating in the waveguide transmission line;
transition the signal to primarily a transverse electromagnetic (TEM) mode signal to propagate in the printed circuit board,
wherein:
the waveguide transmission line has a center conductive ridge within an interior cavity and extending throughout a length of the waveguide transmission line,
the printed circuit board comprises a stripline conductor provided between a first ground plane and a second ground plane, the first and second ground planes being electrically connected by a plurality of conductive plated-through-hole (PTH) vias; and
the stripline includes at least one of an open or short-circuited tuning stub provided at a distance from the center conductive ridge to impedance match the waveguide transmission line medium to the printed circuit board stripline medium, and
the waveguide transmission line includes a conductive interface configured to mate with a first metalized region of the printed circuit board that is electrically coupled to the first ground plane.

12. The structure of claim 11, wherein the waveguide transmission line operates as a coaxial waveguide having a substantially circular cross section and wherein the center conductive ridge operates as a center conductor,
wherein the waveguide transmission line further includes short-circuit stubs along the center conductive ridge within the waveguide transmission line, the short-circuit stubs coupled to inner walls of the waveguide transmission line.

13. The structure of claim 12, wherein the first metalized region of the printed circuit board that is coupled to the first ground plane and a second metalized region of the printed circuit board that is electrically coupled to the stripline have a shape corresponding to a shape of the conductive interface configured to guide the signal from the waveguide transmission line medium to the printed circuit board stripline medium.

14. The structure of claim 13, wherein the printed circuit board is coupled to the waveguide transmission line at substantially a ninety-degree angle transitioning the signal from primarily a transverse electric (TE) mode signal propagating in the waveguide transmission line to primarily a transverse electromagnetic (TEM) mode signal propagating in the printed circuit board.

15. The structure of claim 13, wherein the at least one tuning stub is one of an open or short-circuited tuning stub, and
wherein when the tuning stub is a short-circuited tuning stub, an end of the stub is electrically coupled to both of the first ground plane and the second ground plane by some of the conductive PTH vias.

16. A structure comprising: an additively manufactured waveguide transmission line coupled to a printed circuit board configured to transition a signal from a waveguide transmission line medium to printed circuit board stripline medium, wherein:
the waveguide transmission line has a center conductive ridge within an interior cavity and extending throughout a length of the waveguide transmission line,
the printed circuit board comprises a stripline conductor provided between a first ground plane and a second ground plane, the first and second ground planes being electrically connected by a plurality of conductive plated-through-hole (PTH) vias,
wherein the stripline includes at least one of an open or short-circuited tuning stub provided at a distance from the center conductive ridge, and
wherein the waveguide transmission line includes a conductive interface configured to mate with a first metalized region of the printed circuit board that is electrically coupled to the first ground plane,
wherein the waveguide transmission line operates as a coaxial waveguide having a substantially circular cross section and wherein the center conductive ridge operates as a center conductor.

17. The structure of claim 16, wherein the waveguide transmission line further includes short-circuit stubs along the center conductive ridge within the waveguide transmission line, the short-circuit stubs coupled to inner walls of the waveguide transmission line.

18. The structure of claim 17, wherein the waveguide transmission line is a three-dimensional (3D) printed waveguide transmission line formed by additive manufacturing (AM) process, and
wherein the center conductive ridge is connected at various locations to inner walls of the waveguide transmission line to provide the short-circuit stubs and to support the center conductive ridge, wherein gaps are provided in between the various locations.

19. The structure of claim 18, wherein the first metalized region of the printed circuit board that is coupled to the first ground plane and a second metalized region of the printed circuit board that is electrically coupled to the stripline have a shape corresponding to a shape of the conductive interface configured to guide the signal from the waveguide transmission line medium to the printed circuit board stripline medium.

20. The structure of claim 19, wherein the printed circuit board is coupled to the waveguide transmission line at substantially a ninety-degree angle transitioning the signal from primarily a transverse electric (TE) mode signal propagating in the waveguide transmission line to primarily a transverse electromagnetic (TEM) mode signal propagating in the printed circuit board.
